(19) United States
(12) Patent Application Publication
(10) Pub. No.: US 2019/0047117 A1
(43) Pub. Date: Feb. 14, 2019

(54) SUBSTRATE POLISHING APPARATUS AND METHOD

(71) Applicant: EBARA CORPORATION, Tokyo (JP)

(72) Inventors: Yuki WATANABE, Tokyo (JP); Keita YAGI, Tokyo (JP)

(21) Appl. No.: 16/055,733

(22) Filed: Aug. 6, 2018

(30) Foreign Application Priority Data
Aug. 8, 2017 (JP) 2017-153238

(51) Int. Cl. B24B 49/12; G01B 11/06; B24B 37/013; B24B 37/04; B24B 37/32; B24B 37/20; B24B 7/22

(52) U.S. Cl. CPC B24B 49/12; G01B 11/06; B24B 37/013; B24B 7/228; B24B 37/32; B24B 37/20; B24B 37/042

(57) ABSTRACT

A substrate polishing apparatus includes: a top ring for pressing a substrate against a polishing pad; a press mechanism that independently presses a plurality of regions of the substrate; a spectrum generating unit that directs light onto a surface of the substrate to be polished, receives reflected light, and calculates a reflectivity spectrum corresponding to the wavelength of the reflected light; a profile signal generating unit that generates a polishing profile of the substrate when the reflectivity spectra at a plurality of measurement points on the substrate are input; a pressure control unit that controls pressing forces to be pressed against the plurality of regions of the substrate by the press mechanism based on the polishing profile; and an end detecting unit that detects an end of substrate polishing without being based on the polishing profile.

### FIELD

The present invention relates to a substrate processing apparatus and method used to process the surface of a substrate, such as a semiconductor wafer.

### BACKGROUND AND SUMMARY

A substrate polishing apparatus is widely known which is used to polish the surface of a substrate, such as a semiconductor wafer, by so-called chemical mechanical polishing (CMP). Such a substrate polishing apparatus includes a film thickness measuring device for measuring the film thickness of a substrate being polished.

A known film thickness measuring device is an optical film thickness measuring device. This optical film thickness measuring device irradiates the surface of a substrate with measurement light and receives measurement light reflected off the substrate in order to acquire the spectrum. Since the spectral characteristics of reflected light change depending on the film thickness of the substrate, a film thickness measuring device can estimate the film thickness of the substrate based on the acquired spectrum of the reflected light.

The substrate polishing apparatus including such a film thickness measuring device acquires film thickness distribution (profile) in a plurality of regions in a substrate plane from information on the film thickness of the substrate acquired by the film thickness measuring device. The profile is controlled so as to make the film thickness uniform in the substrate plane by controlling a pressure of a membrane pressing the substrate based on the profile.

With increasing degrees of integration and density of semiconductor devices, circuit wiring has become finer and a larger number of layers have been used in multilayer wiring. For this reason, the planarization of a semiconductor device surface and the accuracy of detecting an interface between a layer to be polished and a base layer during the manufacture process have become increasingly important. It is therefore preferred to appropriately control the timing of the termination of polishing of the substrate.

The conventional substrate polishing apparatus that controls a pressure of the membrane is configured to estimate a film thickness of a substrate based on a profile signal for controlling the pressure of the membrane and determine end of polishing of the substrate. However, the film thickness estimation based on the profile signal deteriorates the accuracy of detecting an interface because the profile saturates around the interface with the base layer. Since the profile signal varies due to the effect of the base layer, the accuracy of estimating the film thickness is not stable.

On the other hand, when attempting to determine end of the polishing of the substrate by regarding the time response signal of the spectrum of the reflected light as an input signal, the substrate polishing apparatus cannot detect the film thickness distribution in the surface of the substrate to be polished with high accuracy, which prevents the pressure of the membrane from being appropriately controlled.

An object of the present invention is to provide a substrate polishing apparatus and method that allow a pressure of a membrane pressing a substrate to be appropriately controlled and allow the end of polishing of a substrate to be appropriately detected.

A substrate polishing apparatus that is one aspect of the present invention includes: a top ring for pressing a substrate against a polishing pad; a press mechanism that independently presses a plurality of regions of the substrate; a spectrum generating unit that directs light onto a surface of the substrate of interest for polishing, receives reflected light, and calculates a reflectivity spectrum corresponding to the wavelength of the reflected light; a profile signal generating unit that generates a polishing profile of the substrate when the reflectivity spectra at a plurality of measurement points on the substrate are input; a pressure control unit that controls pressing forces to be pressed against the plurality of regions of the substrate by the press mechanism based on the polishing profile; and an end detecting unit that detects an end of substrate polishing without being based on the polishing profile.

In the substrate polishing apparatus, the end detecting unit detects a point of time when an interface with a base layer of a surface of the substrate or a level difference on the surface of the substrate is eliminated. The profile signal generating unit stores spectrum groups including a plurality of reference spectra corresponding to different film thicknesses, and it is preferable to select a reference spectrum having a form closest to a reflectivity spectrum from the spectrum generating unit, and to estimate a film thickness corresponding to the reference spectrum to be the film thickness of a wafer being polished.

Alternatively, in the profile signal generating unit, it is preferable that a reflectivity spectrum from the spectrum generating unit is subjected to a Fourier transform process to determine a thickness of the wafer and an intensity of a frequency component corresponding to the thickness and estimate the film thickness of the wafer based on a peak of the determined spectrum. It is also preferable that the profile signal generating unit extracts an extreme point indicating a wavelength having a maximum value or a minimum value for a reflectivity spectrum from the spectrum generating unit to estimate the film thickness of the wafer based on an amount of change in the extreme point with the polishing of the substrate.

In the above-described substrate polishing apparatus, it is preferable to input the reflectivity spectrum from the spectrum generating unit to the end detecting unit. It is preferable that the end detecting unit calculates indexes which are set with reference to predetermined two wavelengths, of reflectivity spectra from the spectrum generating unit, and calculates an amount of polishing by detecting the maximum value of the index in a temporal change. Alternatively, it is preferable that the end detecting unit sums the temporal change in the reflectivity spectra from the spectrum generating unit to determine a cumulative amount of change in spectrum, and determines a time point at which the cumulative amount of change in spectrum reaches a predetermined value to be the termination of the polishing.

A substrate polishing method that is one aspect of the present invention is a method for polishing a surface of a substrate by a polishing pad, a plurality of regions of the substrate capable of being independently pressed by a press mechanism, the method including the steps of: directing light onto a surface of the substrate of interest for polishing, receiving reflected light, and calculating a reflectivity spectrum corresponding to a wavelength of the reflected light; generating a polishing profile of the substrate when the reflectivity spectra at a plurality of measurement points on the substrate are input; controlling pressing forces to be pressed against the plurality of regions of the substrate by the press mechanism based on the polishing profile; and detecting an end of substrate polishing without being based on the polishing profile.

According to the present invention, an end of substrate polishing is detected independently from a polishing profile of a substrate, thereby capable of appropriately controlling a pressure of a membrane pressing the substrate and appropriately detecting the end of the substrate polishing.

### BRIEF DESCRIPTION OF THE DRAWINGS

FIG. 1 is a diagram schematically showing the configuration of a substrate polishing apparatus according to one embodiment of the present invention.

FIG. 2 is a cross-sectional view showing the structure of a polishing head.

FIG. 3 is a cross-sectional view showing the configuration of an optical measuring instrument included in the substrate polishing apparatus.

FIG. 4 is a plan view showing a positional relationship between a wafer and a polishing table.

FIG. 5 is a block diagram showing the configuration of a processing unit.

FIG. 6 is an explanatory diagram showing the spectrum of reflected light from the wafer.

### DETAILED DESCRIPTION OF NON-LIMITING EXAMPLE EMBODIMENTS

A substrate processing apparatus according to one embodiment of the present invention will now be described with reference to the accompanying drawings. It should be noted that the same or corresponding components will be denoted by the same reference numeral and overlapping description will be omitted.

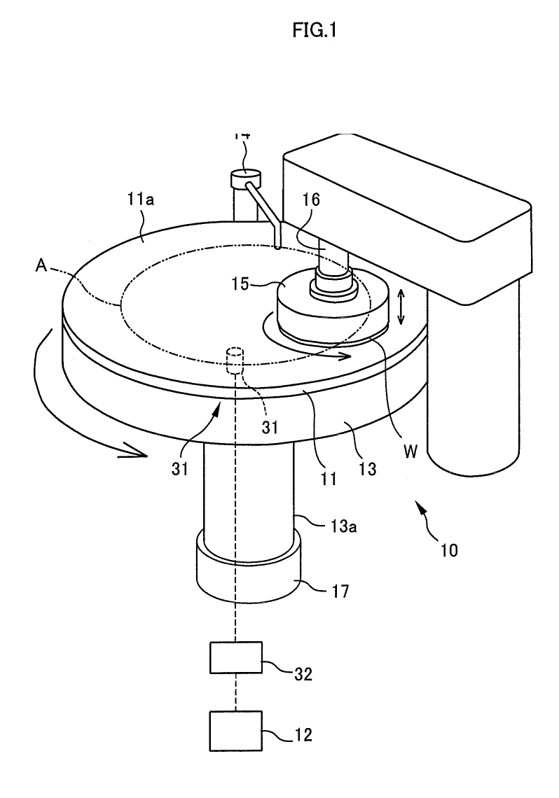

FIG. 1 is a diagram showing a polishing apparatus according to one embodiment of the present invention. As shown in FIG. 1, a polishing apparatus 10 includes: a polishing table 13 mounted with a polishing pad 11 having a polishing surface 11a; a polishing head 15 used to hold a wafer W, which is an example of substrate, and polish the wafer W while pressing it against the polishing pad 11 on the polishing table 13; a polishing solution supply nozzle 14 for supplying a polishing solution (e.g., a slurry) onto the polishing pad 11; and a polishing control unit 12 for controlling the polishing of the wafer W.

The polishing table 13 is joined to an underlying table motor 17 through a table shaft 13a, and the table motor 17 allows the polishing table 13 to rotate in the direction indicated by the arrow. The polishing pad 11 is attached to the top surface of this polishing table 13, and the top surface of the polishing pad 11 constitutes the polishing surface 11a for polishing the wafer W. The polishing head 15 is joined to the bottom end of a polishing head shaft 16. The polishing head 15 is configured to hold the wafer W at the bottom surface by vacuum suction. The polishing head shaft 16 is configured to vertically move through a vertical move mechanism not shown in the drawing.

The wafer W is polished in the following manner. The polishing head 15 and the polishing table 13 are rotated in the respective directions indicated by the arrows, and a polishing solution (slurry) is supplied from the polishing solution supply nozzle 14 onto to the polishing pad 11. In this state, the polishing head 15 presses the wafer W against the polishing surface 11a of the polishing pad 11. The surface of the wafer W is polished by mechanical effects of abrasive grain contained in the polishing solution and chemical effects of the polishing solution.

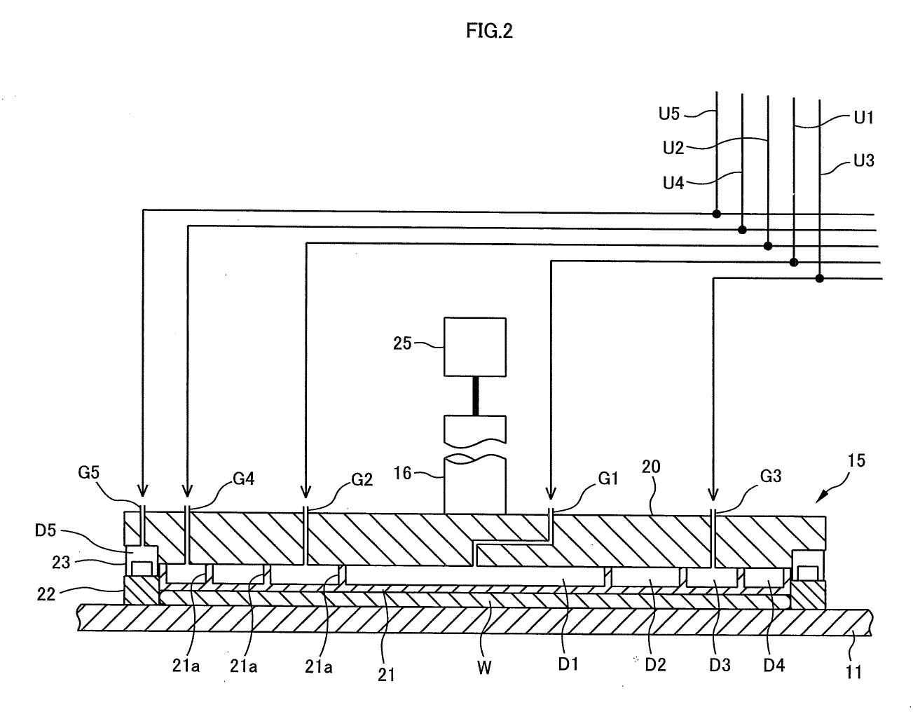

FIG. 2 is a cross-sectional view showing the structure of the polishing head 15. The polishing head 15 includes a circular plate-like carrier 20, a circular flexible elastic film 21 that is disposed below the carrier 20 and defines a plurality of pressure chambers (air-bags) D1, D2, D3, and D4, and a retainer ring 22 that is disposed in such a manner that it surrounds the wafer W and presses the polishing pad 11. The pressure chambers D1, D2, D3, and D4 are formed between the elastic film 21 and the bottom surface of the carrier 20.

The elastic film 21 has a plurality of ring-shaped partition walls 21a, and the pressure chambers D1, D2, D3, and D4 are separated by these partition walls 21a. The pressure chamber D1 disposed in the central portion has a circular shape, and the other pressure chambers D2, D3, and D4 have a ring shape. These pressure chambers D1, D2, D3, and D4 are arranged concentrically. In the present embodiment, the polishing head 15 includes the four pressure chambers, but in the present invention, the number of pressure chambers is not limited to four, and the polishing head 15 may include one to three pressure chambers, or five or more pressure chambers.

The pressure chambers D1, D2, D3, and D4 are connected to fluid lines G1, G2, G3, and G4 so that a pressure-adjusted pressurized fluid (e.g., pressurized air or other pressurized gases) can be supplied into the pressure chambers D1, D2, D3, and D4 through the fluid lines G1, G2, G3, and G4. The fluid lines G1, G2, G3, and G4 are connected to vacuum lines U1, U2, U3, and U4 so that negative pressure can be formed in the pressure chambers D1, D2, D3, and D4 through the vacuum lines U1, U2, U3, and U4.

The internal pressures on the pressure chambers D1, D2, D3, and D4 can be changed independently of each other through a processing unit 32, which will be described later, and the polishing control unit 12; thus, the polishing pressures on the respective four regions of the wafer W, i.e., the central portion, inner intermediate portion, outer intermediate portion, and edge portion can be independently adjusted.

The ring-shaped elastic film 21 is disposed between the retainer ring 22 and the carrier 20. The ring-shaped pressure chamber D5 is formed in the elastic film 21. The pressure chamber D5 is connected to the fluid line G5 so that a pressure-adjusted pressurized fluid (e.g., pressurized air) can be supplied into the pressure chamber D5 through the fluid line G5. In addition, the fluid line G5 is connected to the vacuum line U5 so that negative pressure can be formed in the pressure chamber D5 through the vacuum line U5.

With changes in the pressure in the pressure chamber D5, the elastic film 21 and the entire retainer ring 22 vertically move, so that the pressure in the pressure chamber D5 is applied to the retainer ring 22 and the retainer ring 22 can directly press the polishing pad 11 independently of the elastic film 21. During polishing of the wafer W, the retainer ring 22 presses the polishing pad 11 around the wafer W while the elastic film 21 presses the wafer W against the polishing pad 11.

The carrier 20 is fixed to the bottom end of a head shaft 16. The head shaft 16 is joined to the vertical move mechanism 25. This vertical move mechanism 25 is configured to move up and down the head shaft 16 and the polishing head 15, and locate the polishing head 15 at a predetermined height. A combination of a servo motor and a ball screw mechanism is used as this vertical move mechanism 25 functioning as this polishing head positioning mechanism.

The vertical move mechanism 25 locates the polishing head 15 at a predetermined height. In this state, a pressurized fluid is supplied to the pressure chambers D1 to D5. Receiving the pressure in the pressure chambers D1 to D4, the elastic film 21 presses the wafer W against the polishing pad 11 and, receiving the pressure in the pressure chamber D5, the retainer ring 22 presses the polishing pad 11. In this state, the wafer W is polished.

The polishing apparatus 10 includes an optical measuring instrument 30 that acquires the film thickness of the wafer W. The optical measuring instrument 30 includes an optical sensor 31 that acquires an optical signal varying according to the film thickness of the wafer W, and a processing unit 32 that determines the film thickness distribution of the wafer W on the basis of the optical signal and determines the termination of polishing of the wafer W. The optical sensor 31 is disposed in the polishing table 13, and the processing unit 32 is connected to the polishing control unit 12. As indicated by the sign A, the optical sensor 31 rotates integrally with the polishing table 13 and acquires an optical signal related to the wafer W held by the polishing head 15. The optical sensor 31 is connected to the processing unit 32, and the optical signal acquired through the optical sensor 31 is transmitted to the processing unit 32.

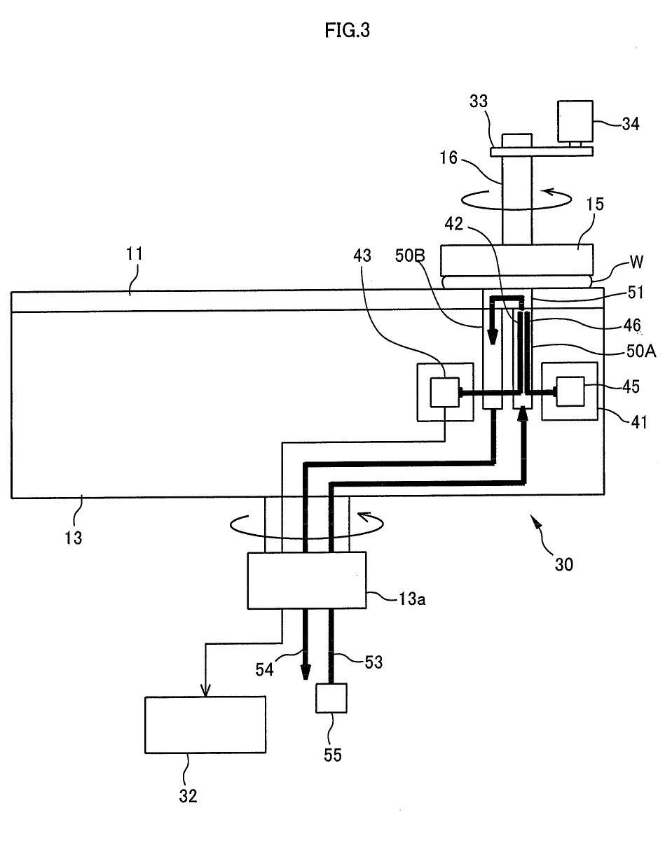

FIG. 3 is a schematic cross-sectional view of a polishing apparatus including the optical measuring instrument 30. The polishing head shaft 16 is coupled to the polishing head motor 34 through a coupler 33, such as a belt, and is made rotatable. Rotation of this polishing head shaft 16 causes the polishing head 15 to rotate in the direction indicated by the arrow.

The optical measuring instrument 30 includes the optical sensor 31 and the processing unit 32. The optical sensor 31 is configured to direct light onto the surface of the wafer W, receive reflected light from the wafer W, and disperse the reflected light according to the wavelength. The optical sensor 31 includes a phototransmitter 41 that directs light onto a surface of the wafer W of interest for polishing, an optical fiber 42 that serves as a photoreceptor receiving reflected light returning from the wafer W, and a spectroscope 43 that disperses reflected light from the wafer W according to the wavelength and measures the intensity of the reflected light over a predetermined range of wavelength.

The polishing table 13 has a first hole 50A and a second hole 50B opened on the top surface. In addition, the polishing pad 11 has a through-hole 51 in a position corresponding to the holes 50A and 50B. The holes 50A and 50B are communicated with the through-hole 51. The through-hole 51 is opened on the polishing surface 11a. The first hole 50A is coupled to a liquid supply source 55 through a liquid supply path 53 and a rotary joint (not shown in the drawing), and the second hole 50B is coupled to a liquid exhaust path 54.

The phototransmitter 41 includes a light source 45 emitting multiple-wavelength light, and an optical fiber 46 connected to the light source 45. The optical fiber 46 is an optical transmission line that guides light emitted by the light source 45, to the surface of the wafer W. The front ends of the optical fibers 46 and 42 are located in the first hole 50A and in the vicinity of the surface of the wafer W of interest for polishing. The front ends of the optical fibers 46 and 42 are disposed so as to face the wafer W held by the polishing head 15. Each time the polishing table 13 rotates, the plurality of regions of the wafer W is irradiated with light. Preferably, the front ends of the optical fibers 46 and 42 are disposed so as to pass through the center of the wafer W held by the polishing head 15.

During polishing of the wafer W, water (preferably pure water) is supplied from the liquid supply source 55 to the first hole 50A through the liquid supply path 53 as a transparent liquid, and is filled in the space between the bottom surface of the wafer W and the front ends of the optical fibers 46 and 42. Water further flows into the second hole 50B and is exhausted through the liquid exhaust path 54. The polishing solution is exhausted together with water, thereby ensuring an optical path. The liquid supply path 53 is provided with a valve (not shown in the drawing) in synchronization with the rotation of the polishing table 13. This valve operates in such a manner that it stops the water flow or reduces the flow rate of water when the wafer W is not located over the through-hole 51.

Two optical fibers 46 and 42 are disposed in parallel with each other, and their front ends are disposed perpendicularly to the surface of the wafer W. The optical fiber 46 is configured to direct light perpendicularly to the surface of the wafer W.

During polishing of the wafer W, light from the phototransmitter 41 is directed onto the wafer W, and the optical fiber (photoreceptor unit) 42 receives reflected light from the wafer W. The spectroscope 43 measures the intensity of reflected light at each wavelength within a predetermined range of wavelength, and transmits the acquired light intensity data to the processing unit 32. This light intensity data is an optical signal that reflects the film thickness of the wafer W and is composed of the intensity of the reflected light and the corresponding wavelength.

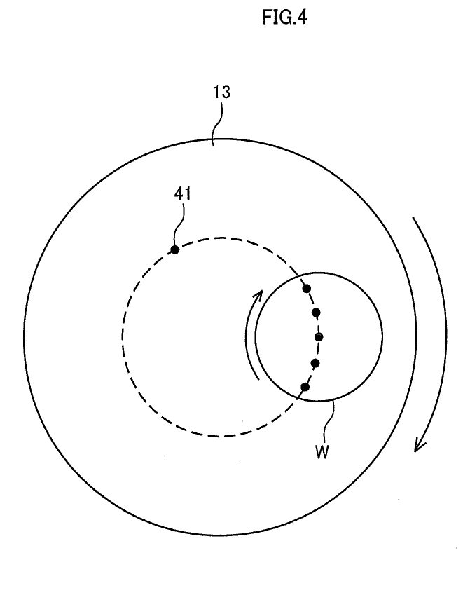

FIG. 4 is a plan view showing a positional relationship between the wafer W and the polishing table 13. The phototransmitter 41 and the photoreceptor unit 42 face the surface of the wafer W. Each time the polishing table 13 rotates, the phototransmitter 41 directs light onto a plurality of regions (a plurality of black dots in FIG. 4) including the center of the wafer W.

The wafer W has a bottom-layer film and a top-layer film (e.g., a silicon layer or insulating film) formed on the bottom-layer film. Light incident on the wafer W reflects off an interface between a medium (e.g., water) and the top-layer film and an interface between the top-layer film and the bottom-layer film, and interference of lightwaves reflected off these interfaces occurs. The way of this interference of lightwaves changes depending on the thickness of the top-layer film (i.e., optical length). Accordingly, the spectrum generated from the reflected light from the wafer W changes depending on the thickness of the top-layer film. The spectroscope 43 disperses reflected light according to the wavelength, and measures the intensity of the reflected light for each wavelength.

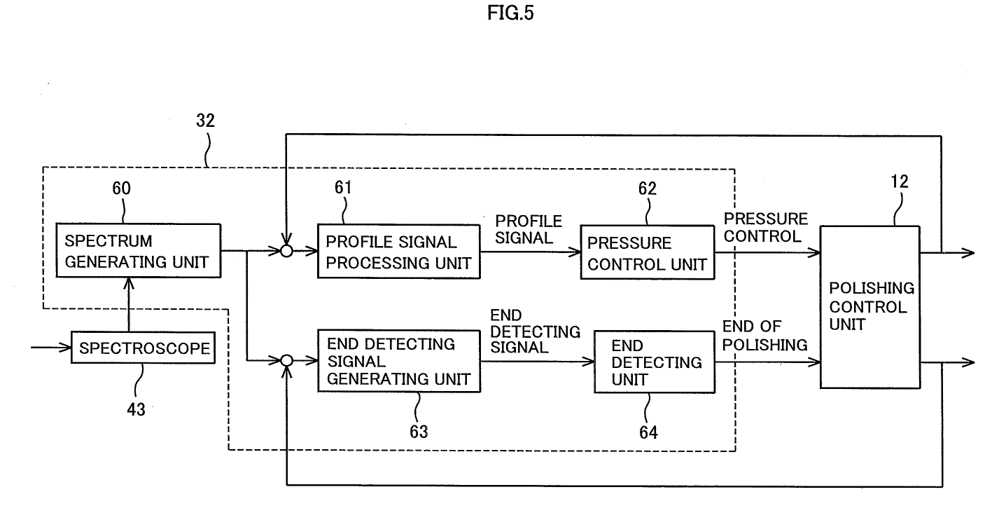

FIG. 5 is a block diagram showing an example of the configuration of the processing unit 32. The processing unit 32 includes a spectrum generating unit 60 that generates a reflectivity spectrum of reflected light from the wafer W, a profile signal processing unit 61, a pressure control unit 62, an end detecting signal generating unit 63, and an end detecting unit 64.

The spectrum generating unit 60 generates a spectrum from reflected light intensity data (an optical signal) obtained through the spectroscope 43. Hereinafter, a spectrum generated from reflected light from the polished wafer W is referred to as a measuring spectrum (reflectivity spectrum). This measuring spectrum is represented by a line graph (i.e., a spectral waveform) showing a relationship between the wavelength and intensity of light. Light intensity can be represented by a reflectivity or relative value, such as a relative reflectivity.

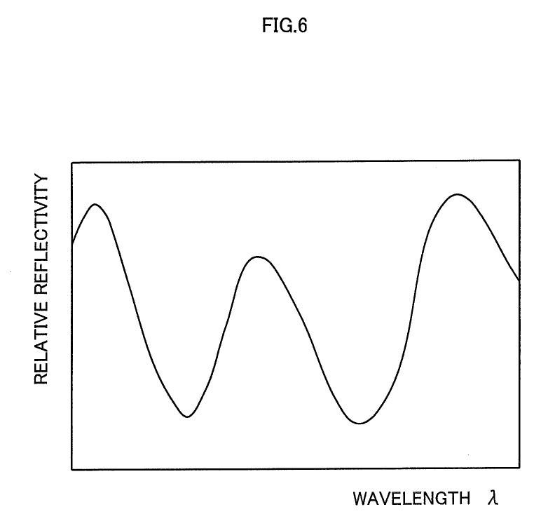

FIG. 6 is a diagram showing a measuring spectrum generated by the spectrum generating unit 60. The horizontal axis represents the light wavelength, and the vertical axis represents the relative reflectivity calculated based on the intensity of light reflected off the wafer W. Here, a relative reflectivity is an index representing the reflection intensity of light, specifically, a ratio between light intensity and a predetermined reference intensity. At each wavelength, dividing the light intensity (measured intensity) by a reference intensity removes unneeded noise, such as intensity variations unique to each optical system or light source of the apparatus, from the measured intensity, thereby yielding a measuring spectrum that reflects information of a film thickness only.

A reference intensity can be defined as, for example, a light intensity obtained when a silicon wafer with no film formed thereon (a bare wafer) is water-polished in the presence of water. In actual polishing, a corrected measured intensity is determined by subtracting a dark level (a background intensity obtained under the condition where light is shut out) from a measured intensity; a corrected reference intensity is determined by subtracting the dark level from a reference intensity; and a relative reflectivity is determined by dividing the corrected measured intensity by the corrected reference intensity. To be specific, the relative reflectivity R(λ) can be determined using the equation below.

R(λ)=(E(λ)−D(λ))/(B(λ)−D(λ))

Here, λ represents a wavelength, E(λ) represents the intensity of light at the wavelength λ reflected off the wafer, B(λ) represents a reference intensity at the wavelength λ, and D(λ) is a background intensity (dark level) at the wavelength λ obtained in the state where light is shut out.

The processing unit 32, in response to a spectrum signal (reflectivity spectrum) from the spectrum generating unit 60, generates pressure control information for controlling pressures in the pressure chambers D1 to D5 and polishing termination information for terminating the polishing of the substrate by detecting an end of the polishing, and transmits the pressure control information and the polishing termination information to the polishing control unit 12.

The profile signal processing unit 61, in response to a spectrum signal (reflectivity spectrum) from the spectrum generating unit 60, calculates a profile in a plurality of regions in a radial direction of the wafer W (the film thickness distribution in the radial direction of the wafer W), and outputs the calculated profile as a profile signal. The pressure control unit 62 outputs a signal for adjusting the pressures in the respective pressure chambers D1 to D5 so that pressing forces of an elastic film 21 against the wafer W can be uniform on the basis of the profile signal received from the profile signal processing unit 61. It should be noted that the profile signal processing unit 61 may be configured integrally with the pressure control unit 62.

Here, a method for calculating a profile of the wafer W may be, for example, a reference spectrum (Fitting Error) method, a Fast Fourier Transform (FFT) method, or a Peak-Valley method.

In the case of the reference spectrum method, a plurality of spectrum groups including a plurality of reference spectra corresponding to different film thicknesses is prepared. A spectrum group including a reference spectrum having a form closest to a spectrum signal (reflectivity spectrum) from the spectrum generating unit 60 is selected. Further, during the polishing of the wafer, a measuring spectrum for measuring the film thickness is generated, a reference spectrum having the closest form is selected from the selected spectrum group, and a film thickness corresponding to the reference spectrum is estimated to be the film thickness of the wafer being polished. The information on the film thickness estimated in this method is acquired at a plurality of points in the radial direction of the wafer W, thereby acquiring the profile.

In the case of the FFT method, a spectrum signal (reflectivity spectrum) from the spectrum generating unit 60 is subjected to Fast Fourier Transform (FFT) to extract a frequency component and the related intensity, and the obtained frequency component is converted into the thickness of a layer to be polished, by using a predetermined relational expression (a function that represents the thickness of the layer to be polished and can be determined from a measured value and the like). Accordingly, a frequency spectrum indicating a relationship between the thickness of the layer to be polished and the intensity of the frequency component is generated. If the peak intensity of the spectrum corresponding to the thickness of the layer of interest for polishing obtained by conversion from the frequency component exceeds a threshold, the frequency component (the thickness of the layer of interest for polishing) corresponding to that peak intensity is estimated to be the film thickness of the wafer being polished. The information on the film thickness estimated in this method is acquired at a plurality of points in the radial direction of the wafer W, thereby acquiring the profile.

In the case of the Peak Valley method, for a spectrum signal (reflectivity spectrum) from the spectrum generating unit 60, a wavelength which is an extreme point indicating the extreme value (maximum value or minimum value) is extracted. As the film thickness of a layer to be polished decreases, the wavelength which is the extreme point shifts toward the short wavelength side; therefore, monitoring the extreme point with the polishing of the wafer, the film thickness of the layer to be polished can be estimated. Further, at a plurality of points arranged in the radial direction of the wafer, monitoring the wavelength which is the extreme point allows the profile to be obtained.

It should be noted that the above-described methods for calculating the profile may be used alone or as a combination of a plurality of methods (for example, a method for outputting an average value of the values calculated in the respective methods).

The end detecting signal generating unit 63, in response to a spectrum signal (reflectivity spectrum) from the spectrum generating unit 60, outputs a signal (end detecting signal) for monitoring the progress of polishing of the wafer W. The end detecting unit 64 receives the end detecting signal from the end detecting signal generating unit 63, and when the signal characteristics have changed (for example, when the interface with the base layer of the surface of the substrate has been detected or the level difference on the surface of the substrate has been eliminated), the end detecting unit 64 generates a signal (polishing termination signal) for terminating the polishing the layer of interest for polishing, and output the signal to the polishing control unit 12. It should be noted that the end detecting signal generating unit 63 may be configured integrally with the end detecting unit 64.

Here a method for generating a signal (end detecting signal) for monitoring the progress of polishing of the wafer W may be, for example, a Spectrum Index method, or a Polishing Index method. It should be noted that these methods for generating the signal may be used alone or as a combination of a plurality of methods (for example, a method for generating the polishing termination signal when the termination of polishing has been detected in all of the methods (or any of the methods)).

In the Spectrum Index method, in response to a spectrum signal (reflectivity spectrum) from the spectrum generating unit 60, indexes which are set with reference to predetermined two points (two wavelengths) are calculated and a polishing quantity is calculated by detecting the maximum value of the indexes in a temporal change, or the features of the indexes in a temporal change (threshold, rapid decrease or increase, etc.) may be detected to detect the presence or absence of the layer to be polished (i.e., whether the polishing may be terminated). Here, as the indexes as characteristics values, the indexes Index_{λ1, λ2} with respect to the wavelengths λ1, λ2 are calculated using the equation below, for example.

A_{λk}∫R(λ)W_{λk}(λ)dλ

Index_{λ1, λ2}=A_{λ1}/(A_{λ1}+A_{λ2})

Where, R(λ) represents the relative reflectivity R(λ), and W_{λk}(λ) represents a weighting function centered at the wavelength λk (i.e., shows the maximum value at the wavelength λk).

In the case of the Polishing Index method, in response to a spectrum signal (reflectivity spectrum) from the spectrum generating unit 60, the amount of change in the spectrum per predetermined time is calculated, and the amount of change in the spectrum is summed with polishing time, thereby determining a cumulative amount of change in spectrum. The cumulative amount of change in spectrum monotonously increases with the polishing of the wafer, while the film thickness monotonously decreases; therefore, a time point at which the cumulative amount of change in spectrum reaches a predetermined target value can be determined to be the termination of the polishing.

In the above-described embodiment, the termination of polishing of the wafer is determined according to the reflectivity spectrum from the spectrum generating unit 60, but the present invention is not limited to this. The termination of polishing of the wafer may be determined according to the characteristic quantities other than the spectrum while adjusting the pressures in the respective pressure chambers D1 to D5 according to the spectrum of reflected light.

For example, a sensor coil is arranged in the vicinity of the wafer with a conductive film, and the alternating current having a constant frequency is applied to the sensor coil to form an eddy current in the conductive film, and the impedance value as viewed from both terminals of the sensor coil including the conductive film is measured. The measured impedance is separated into a resistance component, a reactance component, and phase and amplitude to be output, and the thickness of the conductive film is estimated by detecting the change in the impedance, thereby capable of determining whether the polishing is terminated (Eddy current (Resistance Eddy Current Monitor) method).

Alternatively, when the polishing of the layer of interest for polishing has been terminated, and the polishing has reached a different material, the polishing frictional force varies, and thereby a driving force of a drive motor of the top ring (i.e., electric power input to the drive motor) varies. It can be determined whether the polishing is terminated by monitoring the variation in the electric power input to the drive motor (Polishing table current (Table Current Monitor) method).

Thus, the profile signal of the film thickness calculated according to the spectrum of reflected light is used only for controlling the internal pressure of the pressure chamber by the elastic film, and it is determined whether the polishing of the substrate is terminated on the basis of the signal independent from the profile signal, thereby capable of uniformly maintaining the polishing pressure on the surface of substrate and improving the accuracy of detecting an interface with a surface of the substrate of interest for polishing when the polishing is terminated.

The above embodiment has been described so that those possessing general knowledge in the technical field that the present invention belongs to can implement the present invention. Various modifications of the above embodiment can be made by those skilled in the art as a matter of course, and the technological thought of the present invention can be applied to other embodiments. The present invention should not be limited to the above-described embodiment and should be construed in the widest range according to the technological thought defined by the claims.

What is claimed is:

1. A substrate polishing apparatus, comprising:
a top ring for pressing a substrate against a polishing pad;
a press mechanism that independently presses a plurality of regions of the substrate;
a spectrum generating unit that directs light onto a surface of the substrate to be polished, receives reflected light, and calculates a reflectivity spectrum corresponding to the wavelength of the reflected light;
a profile signal generating unit that generates a polishing profile of the substrate when the reflectivity spectra at a plurality of measurement points on the substrate are input;
a pressure control unit that controls pressing forces to be pressed against the plurality of regions of the substrate by the press mechanism based on the polishing profile; and
an end detecting unit that detects an end of substrate polishing without being based on the polishing profile.

2. The substrate polishing apparatus according to claim 1, wherein
the end detecting unit detects a point of time when an interface with a base layer of a surface of the substrate or a level difference on the surface of the substrate is eliminated.

3. The substrate polishing apparatus according to claim 1, wherein
the profile signal generating unit stores spectrum groups including a plurality of reference spectra corresponding to different film thicknesses, selects a reference spectrum having a form closest to a reflectivity spectrum from the spectrum generating unit, and estimates a film thickness corresponding to the reference spectrum to be the film thickness of a wafer being polished.

4. The substrate polishing apparatus according to claim 1, wherein
in the profile signal generating unit, a reflectivity spectrum from the spectrum generating unit is subjected to a Fourier transform process to determine a thickness of the wafer and an intensity of a frequency component corresponding to the thickness and estimate the film thickness of the wafer based on a peak of the determined spectrum.

5. The substrate polishing apparatus according to claim 1, wherein
the profile signal generating unit extracts an extreme point indicating a wavelength having a maximum value or a minimum value for a reflectivity spectrum from the spectrum generating unit to estimate the film thickness of the wafer based on an amount of change in the extreme point with the polishing of the substrate.

6. The substrate polishing apparatus according to claim 1, wherein
the reflectivity spectrum from the spectrum generating unit is input to the end detecting unit.

7. The substrate polishing apparatus according to claim 6, wherein
the end detecting unit calculates indexes which are set with reference to predetermined two wavelengths, of reflectivity spectra from the spectrum generating unit, and calculates a polishing amount by detecting the maximum value of the index in a temporal change.

8. The substrate polishing apparatus according to claim 6, wherein
the end detecting unit sums the temporal change in the reflectivity spectra from the spectrum generating unit to determine a cumulative amount of change in spectrum, and determines a time point at which the cumulative amount of change in spectrum reaches a predetermined value to be the termination of the polishing.

9. A substrate polishing method for polishing a surface of a substrate by a polishing pad, a plurality of regions of the substrate capable of being independently pressed by a press mechanism, the method including the steps of:
directing light onto a surface of the substrate of interest for polishing, receiving reflected light, and calculating a reflectivity spectrum corresponding to a wavelength of the reflected light;
generating a polishing profile of the substrate when the reflectivity spectra at a plurality of measurement points on the substrate are input;
controlling pressing forces to be pressed against the plurality of regions of the substrate by the press mechanism based on the polishing profile; and
detecting an end of substrate polishing without being based on the polishing profile.
